(19) United States
(12) Patent Application Publication
(10) Pub. No.: US 2021/0019770 A1
(43) Pub. Date: Jan. 21, 2021

(54) STORE MANAGEMENT DEVICE AND STORE MANAGEMENT METHOD

(71) Applicant: NEC Corporation, Tokyo (JP)

(72) Inventors: Shinya YAMASAKI, Tokyo (JP); Rie SHIMIZU, Tokyo (JP); Koji SUDO, Tokyo (JP)

(73) Assignee: NEC Corporation, Tokyo (JP)

(21) Appl. No.: 16/982,014

(22) PCT Filed: Feb. 22, 2019
(86) PCT No.: PCT/JP2019/006830

§ 371 Date: Sep. 17, 2020

(30) Foreign Application Priority Data
Mar. 20, 2018 (JP) 2018-052718

(51) Int. Cl. G06Q 30/02; G06K 9/00

(52) U.S. Cl. CPC G06Q 30/0201; G06K 9/00288; G06K 9/00926

(57) ABSTRACT

A store management device is configured to select a registered customer corresponding to a visitor who visits a store from among a plurality of registered customers in communication with a terminal device held by the visitor when carrying out identity verification via face authentication of the visitor and to identify the visitor as a processed-subject person subjected to a predetermined process (e.g. a settlement process of purchased products) by way of authentication using a set of biological information of the registered customer corresponding to the visitor and biological information of the visitor which is newly acquired at a timing of executing the predetermined process in the store. Thus, it is possible to improve the accuracy when determining the identification of the visitor.

### TECHNICAL FIELD

The present invention relates to a store management device and a store management method which are configured to authenticate customers in stores.

### BACKGROUND ART

Recently, face authentication settlement systems configured to identify customers in stores via face authentication and to settle payment of purchased goods have been developed. Therefore, the development of technologies that automatically identify customers in stores is required. To automatically settle payment of goods held by customers' hands in stores, for example, it is necessary to automatically identify customers.

It is possible to mention Patent Document 1 and Patent Document 2 that disclose technologies for identifying individuals by way of collation between registered information and persons upon acquiring their facial images. Patent Document 1 discloses an individual identification device configured to identify individuals by way of collation between registered information and facial images and iris images of subject persons. Patent Document 2 discloses an information processing system configured to manage customers via face authentication which is carried out by way of collation between registered information and face information of customers, thus achieving a settlement process using member registration information.

### CITATION LIST

### Patent Literature Document

Patent Document 1: Japanese Patent Application Publication No. 2000-102524
Patent Document 2: Japanese Patent Application Publication No. 2016-126749

### SUMMARY OF INVENTION

### Technical Problem

A high-accuracy face authentication technology may be required to identify customers in stores among numerous registrants in product sales businesses. Recently, face authentication technology has been improved in accuracy so that most people can be accurately authenticated. However, face authentication may involve misidentification rates (e.g. false rejection rates, false acceptance rates), which may cause inaccurate face authentication to mistakenly identify different customers than registered customers in stores.

The present invention is made to solve the aforementioned problem and aims to provide a store management device and a store management method which can reduce misidentification rates in face authentication.

### Solution to Problem

In a first aspect of the present invention, a store management device includes a visitor selection part configured to select a registered customer corresponding to a visitor who visits a store from among a plurality of registered customers in communication with a terminal device held by the visitor when carrying out identity verification via face authentication of the visitor, and a processed-subject identification part configured to identify the visitor as a processed-subject person subjected to a predetermined process by way of authentication using a set of biological information of the registered customer corresponding to the visitor and biological information of the visitor which is newly acquired at a timing of executing the predetermined process in the store.

In a second aspect of the present invention, a store management method includes the steps of: selecting a registered customer corresponding to a visitor who visits a store from among a plurality of registered customers in communication with a terminal device held by the visitor when carrying out identity verification via face authentication of the visitor; and identifying the visitor as a processed-subject person subjected to a predetermined process by way of authentication using a set of biological information of the registered customer corresponding to the visitor and biological information of the visitor which is newly acquired at a timing of executing the predetermined process in the store.

A third aspect of the present invention is directed to a non-transitory computer-readable storage medium having a stored program executed by a computer. The program includes the steps of: selecting a registered customer corresponding to a visitor who visits a store from among a plurality of registered customers in communication with a terminal device held by the visitor when carrying out identity verification via face authentication of the visitor; and identifying the visitor as a processed-subject person subjected to a predetermined process by way of authentication using a set of biological information of the registered customer corresponding to the visitor and biological information of the visitor which is newly acquired at a timing of executing the predetermined process in the store.

### Advantageous Effects of Invention

According to the present invention, it is possible to improve the accuracy of determining identifications of customers used for predetermined processes (e.g. settlement processes of purchased goods).

### BRIEF DESCRIPTION OF DRAWINGS

FIG. 1 is a perspective view of a store layout installed with a store management system according to one embodiment of the present invention.

FIG. 2 shows explanatory diagrams to explain the overview processing of a store management device configured to identify visitors according to one embodiment of the present invention.

FIG. 3 is a perspective view showing the state of a visitor who may select products displayed on a product shelf in a store.

FIG. 4 is a block diagram showing a hardware configuration of the store management device.

FIG. 5 is a functional block diagram of the store management device configured to communicate with a plurality of sensing devices.

FIG. 6 is a flowchart of a visitor-data-table generation process with the store management device.

FIG. 7 is a flowchart showing a first visitor-identifying process with the store management device.

FIG. 8 is a flowchart showing a second visitor-identifying process with the store management device.

FIG. 9 is a block diagram showing a minimum configuration of the store management device.

### DESCRIPTION OF EMBODIMENTS

A store management device and a store management method according to the present invention will be described in detail by way of examples with reference to the accompanying drawings.

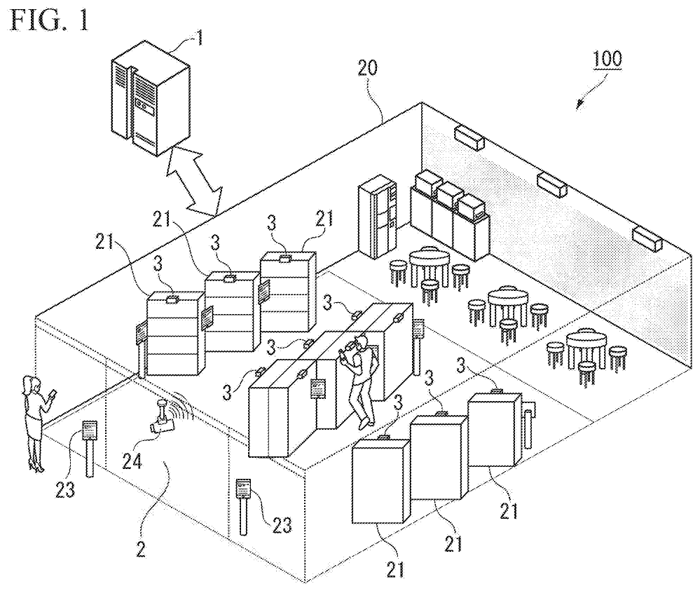

FIG. 1 shows the layout of a store 20 installed with a store management system 100 according to one embodiment of the present invention. The store management system 100 includes a store management device 1 configured to communicate with various types of devices installed in the store 20. The store 20 is equipped with an entry/exit gate 2 and a plurality of product shelves 21. Various types of products are displayed on the product shelves 21.

The store 20 under the management of the store management system 100 has a structure which allows visitors to enter or leave the store 20 through the entry/exit gate 2. The entry/exit gate 2 is equipped with an entry/exit camera 24. The entry/exit camera 24 is configured to capture facial images of visitors who may enter the store 20 through the entry/exit gate 2 so as to transmit facial images to the store management device 1.

The store 20 may be either a manned store in which clerks may be normally stationed or an unmanned store in which no clerks are stationed. A visitor may carry out a series of operations such as touching products displayed on the product shelf 21 by hand, taking products by hand, and putting products into a cart, and then the visitor will leave the store 20 through the entry/exit gate 2. In a time period until a visitor may leave the store after entering the store 20 through the entry/exit gate 2, a plurality of sensing devices such as imaging devices and motion sensors provided in the store 20 may acquire the sensing information such as the feature information and the position information of a visitor, the identification information of products selected by a visitor, and the information for determining the displayed positions of products, thus transmitting the sensing information to the store management device 1. Using the sensing information, the store management device 1 may carry out predetermined processes such as an automatic settlement process, a presentation process for presenting a list of recommended products, and a process for storing information relating to products which a visitor may put into a cart.

For the purpose of carrying out the aforementioned predetermined processes, it is necessary for the store management device 1 to identify visitors with high accuracy. For this reason, the store management device 1 includes a database configured to store the information of numerous customers (e.g. several tens of thousands of customers or several million customers subjected to user registration, hereinafter, referred to as registered customers or registered users) in advance, and therefore the store management device 1 needs to select a registered customer identical to a visitor of the store 20 within the database. As a set of biological information of registered customers serving as visitors, the store management device needs to authenticate a visitor newly entering the store 20 using the visitor's biological information at an execution timing of predetermined processes, thus identifying the visitor subjected to predetermined processes in the store 20.

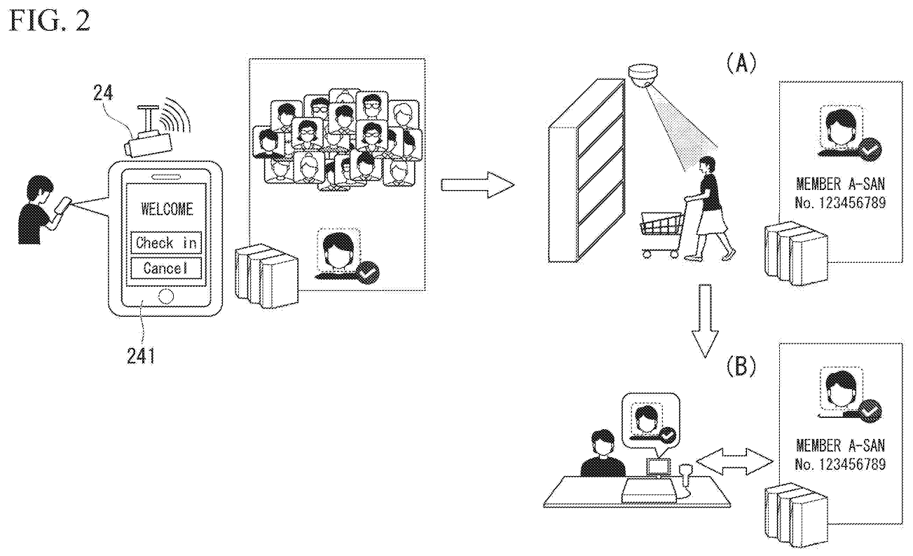

FIG. 2 shows the overview processing of the store management device 1 configured to identify visitors. As shown on the left side of FIG. 2, when a visitor enters into the store 20 through the entry/exit gate 2, the entry/exit camera 24 may capture a facial image of the visitor so as to transmit the facial image to the store management device 1. Based on the visitor's facial image, the store management device 1 may select a customer having the visitor's facial image from among a plurality of registered customers which are stored on the database in advance. The store management device 1 transmits the identity verification information 241 to a terminal device of a visitor when visiting the store 20. Upon receiving a signal indicating that the identity verification information 241 indicates a visitor from the visitor's terminal device, the store management device 1 records the identification information of the registered customer on a visitor data table. FIG. 2(A) shows a process of the store management device 1 to identify a visitor when recording the identification information of products put into a cart by the visitor on the visitor data table. FIG. 2(B) shows a process of the store management device 1 to identify a visitor subjected to an automatic settlement process when automatically settling payment for products put into a cart by the visitor. That is, the store management device 1 is configured to produce the visitor data table which has recorded the biological information of registered customers identical to visitors with reference to the database confirmed to store the biological information with respect to all the registered customers. Subsequently, the store management device 1 may identify a visitor subjected to predetermined processes in the store 20 with reference to the visitor data table. FIG. 2(A) shows a visitor who may leave the store 20 after purchasing products upon identifying the visitor for the sake of an automatic settlement process for settling payment of products purchased by the visitor. FIG. 2(B) shows a visitor who may approach a register counter after purchasing products upon identifying the visitor for the sake of a settlement process after a clerk or a visitor has read the product information such as barcodes attached to purchased products with a barcode reader of a POS terminal.

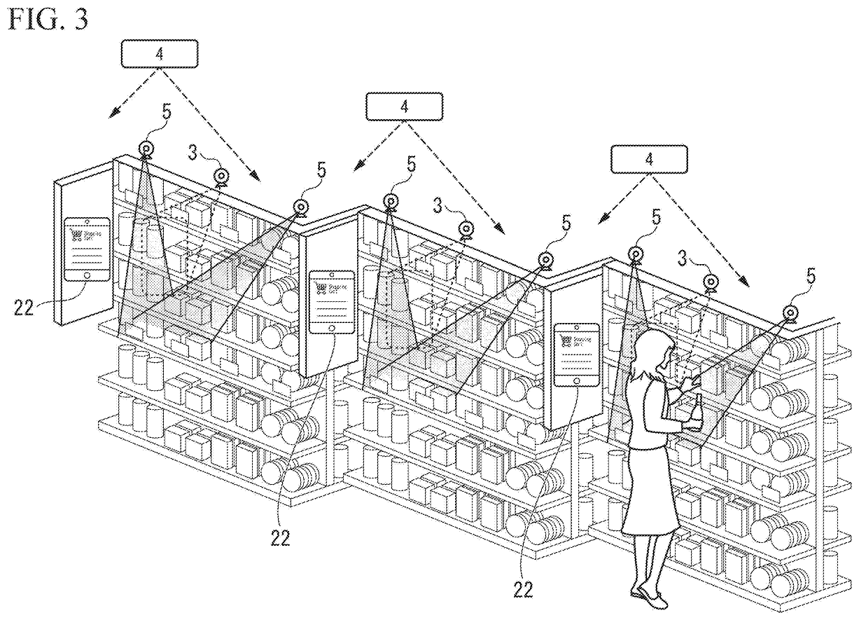

FIG. 3 shows the state of a visitor who may select products displayed on the product shelf 21 in the store 20. In FIG. 3, a plurality of product shelves 21 may be interconnected together in a zigzag manner, wherein a visitor may select products displayed on a right-side shelf. Herein, it is possible to install a plurality of first cameras 3 for each product shelf 21. A motion sensor 4 configured to detect a visitor's action is installed above the product shelf 21. In addition, second cameras 5 configured to capture images with respect to products taken by a visitor's hand or products returned to the product shelf 21 by a visitor are attached to the upper section of the product shelf 21. In this connection, it is not necessary to directly attach the first cameras 3 and the second cameras 5 to the product shelf 21, and therefore the cameras 3, 5 can be installed in the ceiling or the floor of the store 20. That is, the first cameras 3 and the second cameras 5 can be located at any positions in the store 20 which may allow the cameras 3, 5 to capture images with respect to products selected from the product shelf 21 and taken by visitors' hands or products returned to the product shelf 21 by visitors. Alternatively, it is possible to install a store-installed terminal device 22 on the product shelf 21.

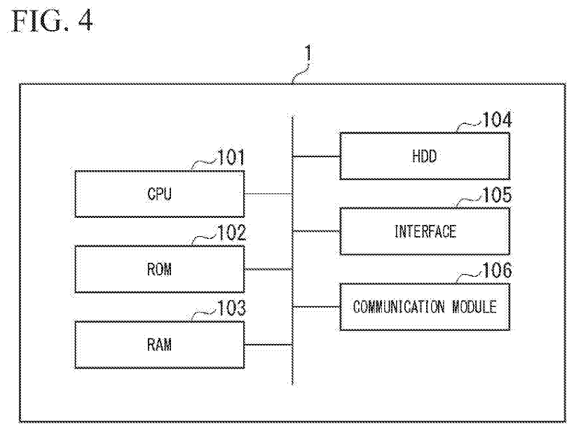

FIG. 4 shows a hardware configuration of the store management device 1. The store management device 1 includes a CPU (Central Processing Unit) 101, a ROM (Read-Only Memory) 102, a RAM (Random-Access Memory) 103, an HDD (Hard Disk Drive) 104, an interface 105, and a communication module 106. In this connection, the HDD 104 may be replaced with an SSD (Solid State Drive).

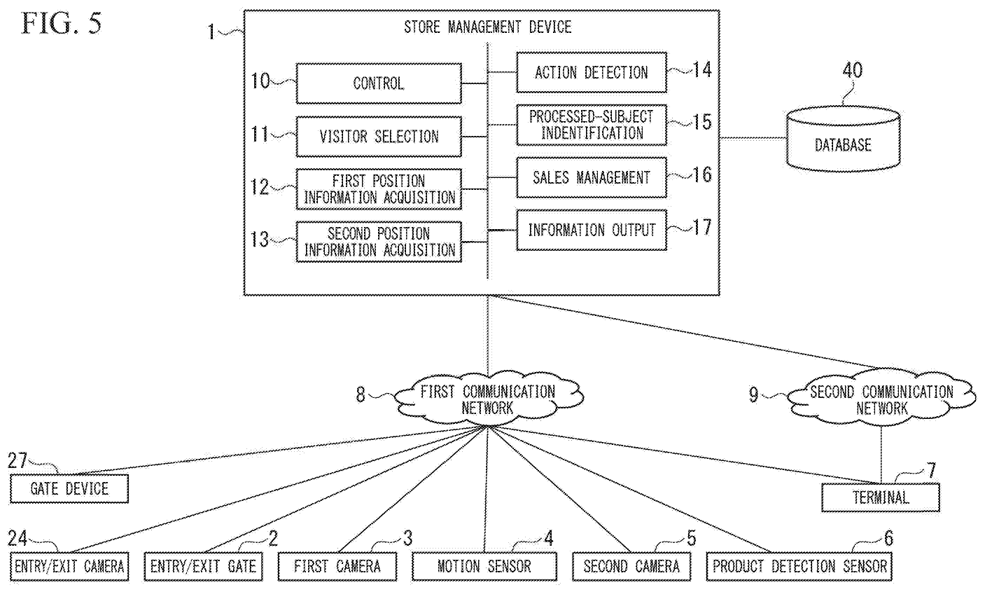

FIG. 5 is a functional block diagram of the store management device 1 configured to communicate with a plurality of sensing devices in the store 20. The store management device 1 may include functional parts to be implemented by the CPU 101 executing a store management program which is stored on a storage unit in advance. As the functional parts, the store management device 1 includes a control part 10, a visitor selection part 11, a first position information acquisition part 12, a second position information acquisition part 13, an action detection part 14, a processed-subject identification part 15, a sales management part 16, and an information output part 17.

As shown in FIG. 5, the store management device 1 is connected to a database 40. The store management device 1 may communicate with various types of sensing devices installed in the store 20 through a first communication network 8, and therefore the store management device 1 is connected to the entry/exit gate 2, the first camera 3, the motion sensor 4, the second camera 5, a product detection sensor 6, a gate device 23, the entry/exit camera 24, and another gate device 27. The first communication network 8 is a dedicated communication network connecting the store management device 1 and various types of sensing devices in the store 20. The store management device 1 may communicate with a terminal device 7 held by a visitor through a second communication network 9. The second communication network 9 may be configured of a mobile-phone network, a wireless communication network, or the Internet. In this connection, the terminal device 7 may be connected to the first communication network 8 when a visitor enters into the store 20.

In the store management device 1, the first position information acquisition part 12 is configured to capture the first position information representing the biological feature information of a visitor approaching the product shelf 21 based on images captured by the first camera 3. The first camera 3 is used to detect the biological feature information of a person reflected in an imaging scope thereof. For example, the first camera 3 is attached to each product shelf 21 to capture a face of a person standing in front of the product shelf 21. In this connection, the biological feature information may be configured of the feature information of a person's face or the feature information of the irises of the person's eyes. The store management device 1 may select a customer identical to a visitor among a plurality of customers stored on a storage unit in advance based on a facial image of a person positioned in front of the product shelf 21 captured by the first camera 3, instead of a facial image of a visitor captured by the entry/exit camera 24. Subsequently, the store management device 1 transmits the identity verification information 241 to the terminal device 7 held by the visitor. Upon receiving from the terminal device 7 a signal indicating that a visitor is identical to a registered customer, the store management device 1 may record the identification information of the registered customer on the visitor data table. Specifically, the store management device 1 is configured to identify a registered customer identical to a visitor and to transmit the identity verification information 241 to the terminal device 7 of the visitor when visiting the store 20. The identity verification information 241 may display a greeting message and icons such as a store-entry button and a cancel button. The visitor's terminal device 7 may display the identity verification information 241 on screen. The visitor may operate the store-entry button in the identity verification information 241 displayed on the terminal device 7. Upon detecting the visitor's operating the store-entry button, the terminal device 7 transmits to the store management device 1 the approval information indicating that the visitor is identical to a registered customer. Upon receiving the approval information from the terminal device 7, the store management device 1 records the identification information of a customer identical to the visitor on the visitor data table. On the other hand, when the visitor is not identical to a customer indicated by the identity verification information 241, the visitor may operate the cancel button with the terminal device 7. Upon detecting that the visitor has operated the cancel button, the terminal device 7 transmits disapproval information to the store management device 1. Upon receiving the disapproval information from the terminal device 7, the store management device 1 stops recording the customer's identification information described in the identity verification information 241 on the visitor data table.

In the store management device 1, the second position information acquisition part 13 is configured to detect the second position information representing the position of a visitor who may approach the product shelf 21 and extend an arm to reach a product with a hand based on the sensing information obtained from the motion sensor 4. For example, the motion sensor 4 is installed at a position on the ceiling of the store above the product shelf 21 and is configured to detect an action of a visitor who may be located below the ceiling of the store 20. Subsequently, the action detection part 14 may detect a visitor's action to move a product displayed on the product shelf 21. For example, the action detection part 14 is configured to detect a visitor's action to move products based on images captured by the second camera 5 configured to capture images of products displayed on the product shelf 21 and the information obtained from the product detection sensor 6. Herein, the visitor's moving action may represent an action of a visitor who may extend an arm toward the product shelf 21 so as to touch a product by hand, an action of a visitor who may hold a product by hand, an action of a visitor who may return the product to the product shelf 21, or an action of a visitor who may put the product in a cart. The processed-subject identification part 15 is configured to determine the biological feature information of a visitor conducting a moving action on a product based on the identification information (ID) of the product subjected to a visitor's moving action and the positional relationship between the first position information and the second position information, thus retrieving from the visitor data table the identification information (ID) of a visitor (or a customer) associated with the biological feature information. Subsequently, the processed-subject identification part 15 may carry out a management measure to allocate the identification information of products subjected to a visitor's moving action to the sales management information associated with the identification information (ID) of a processed-subject person determined via retrieval of the visitor data table. Accordingly, it is possible for the store management device 1 to carry out a management measure as to which product is selected by one visitor. In this connection, the visitor data table may record the information for only the visitors selected from among numerous registered customers (or registered users). As described above, it is possible for the present embodiment to improve the accuracy of determining the identification information (ID) of a processed-subject person.

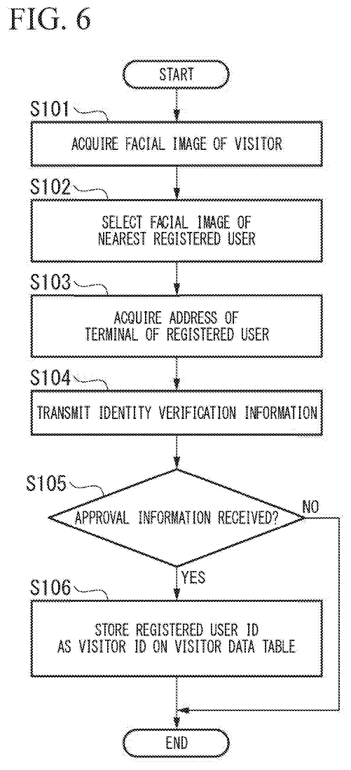

FIG. 6 is a flowchart of a visitor-data-table generation process with the store management device 1 (steps S101 through S106). The visitor selection part 11 acquires a visitor's facial image from the entry/exit camera 24 (S101). The visitor selection part 11 compares a feature quantity of a visitor's facial image with a feature quantity of a facial image of a registered user (or a registered customer) recorded on the database 40, thus selecting a facial image of the nearest registered use (S102). The visitor selection part 11 reads an ID of the registered user associated with the facial image selected from the database 40, thus acquiring an address of the terminal device 7 held by the registered user which is recorded on the database 40 in association with the registered user's ID (S103). The information output part 17 transmits the identity verification information 241 to the terminal device 7 having the address obtained by the visitor selection part 11 (S104).

The identity verification information 241 is screen information which may urge a visitor to confirm their identity, and therefore the terminal device 7 having a touch panel display generates a predetermined image based on the identity verification information (see FIG. 2) so as to display the predetermined image on screen. The predetermined image may display an icon button used to indicate whether or not a person holding the terminal device 7 matches a visitor's identity. When the person holding the terminal device 7 operates the icon button indicating a visitor's identity, the terminal device 7 transmits the approval information indicating a visitor to the store management device 1. On the other hand, when the person holding the terminal device 7 operates an icon button not indicating a visitor's identity, the terminal device 7 transmits the disapproval information not indicating a visitor to the store management device 1.

The visitor selection part 11 determines whether to receive the approval information from the terminal device 7 (S105). Upon receiving the approval information, the visitor selection part 11 records the registered user's ID selected from the database 40, as a visitor ID on the visitor data table (S106). In this case, it is possible to create or update the visitor data table. The visitor selection part 11 reads from the database 40 a facial feature quantity associated with the visitor's ID recorded on the visitor data table, thus recording the facial feature quantity on the visitor data table in association with the visitor's ID. Accordingly, it is possible to create the visitor data table describing the information of only the visitor among numerous registered users. The aforementioned process is one aspect of the processing of the visitor selection part 11 to select a registered user associated with a visitor from among a plurality of registered users stored in advance in communication with the terminal device 7 held by the visitor. Upon receiving the disapproval information, the visitor selection part 11 stops the process for recording the visitor's ID as the registered user's ID selected from the database 40 on the visitor data table.

Using a visitor's facial image captured by the first camera 3 mounted on the product shelf 21 instead of a visitor's facial image captured by the entry/exit camera 24, the visitor selection part 11 of the store management device 1 may create a visitor data table via a similar process as the foregoing steps S101 through S106.

The visitor selection part 11 stores an association between the registered user ID and the ID of the terminal device 7 in advance, wherein upon detecting the terminal device 7 connected to the first communication network 8, the visitor selection part 11 may record the registered user ID associated with the ID of the terminal device 7, as the visitor ID on the visitor data table.

Upon receiving the disapproval information in step S105, or when it is impossible to receive the approval information or the disapproval information due to a time-out event occurring when a predetermined time has elapsed after transmitting the identity verification information 241 to the terminal device 7, the visitor selection part 11 may stop registering the visitor ID on the visitor data table so as to terminate a visitor-data-table generation process. According to the foregoing steps S101 through S106, the visitor selection part 11 may create the visitor data table when triggered by the visitor entering the store 20.

The above visitor data table is used to detect a moving action of a visitor who may move products displayed on the product shelf 21. Specifically, when a visitor passes through the entry/exit gate 2 of the store 20, the entry/exit camera 24 is activated to capture and transmit a facial image of the visitor to the store management device 1. The visitor selection part 11 of the store management device 1 may determine a facial image of a registered user corresponding to the facial image of the visitor by way of collation between a feature quantity of the visitor's facial image and feature quantities of facial images of numerous registered users which are registered in the database 40 in advance. Subsequently, the visitor selection part 11 selects an ID of a registered user recorded on the database 40 as a visitor ID. In addition, the visitor selection part 11 updates the visitor data table by adding the visitor ID. The sales management part 16 of the store management device 1 is configured to generate the sales management information in association with an ID of a person such as a visitor. At the present timing, no product information is associated with the sales management information. The first camera 3 is configured to capture an image of a visitor positioned in front of the product shelf 21 from the side of the product shelf 21, and therefore a still image or a moving image captured by the first camera 3 is transmitted to the store management device 1. The motion sensor 4 attached to the ceiling of the store 20 is configured to detect an action of a visitor who may be positioned below the motion sensor 4 from an upper viewpoint, thus transmitting the detected information to the store management device 1. For example, the detected information of the motion sensor 4 may be a distance image which is produced by converting a distance towards an object or a person detected using infrared rays into an image.

The product detection sensor 6 is installed for each of products displayed on the product shelf 21. Specifically, the product detection sensor 6 has a sheet-like shape laid beneath each product, which may be a pressure sensor for detecting pressure due to each product's weight or a weight sensor for detecting the weight of each product. When a visitor takes a product displayed on the product shelf 21 by hand, for example, the product detection sensor 6 may transmit to the store management device 1 a product-acquisition signal including a sensor ID thereof and coordinates of each product on the product shelf 21 in the store 20. The processed-subject identification part 15 of the store management device 1 may determine a visitor ID with the visitor data table based on coordinates of the skeleton information and the feature information of a visitor acquired from the first camera 3, the motion sensor 4, and the second camera 5 and its association with the detection timing as well as coordinates and a product ID of each product recorded in association with the sensor ID of the product detection sensor 6 and its association with the detection timing. The sales management part 16 of the store management device 1 is configured to update the sales management information in which the visitor ID is recorded on the database 40 in association with the product ID determined from an image captured by the second camera 5. The sales management part 16 may display the sales management information on a display of the store-installed terminal device 22 installed in the product shelf 21 located proximate to the visitor. Accordingly, the visitor is able to confirm a list of products which are taken by hand and put into a cart by oneself.

When the visitor returns a product once taken by hand to the product shelf 21, the product detection sensor 6 may transmit to the store management device 1 the product-return-action information including the sensor ID of the product detection sensor 6 and the position information such as coordinates of the product on the product shelf 21 in the store 20. The sales management part 16 may release an association between the visitor ID and the product ID recorded on the sales management information based on the position information and the product ID stored in association with the sensor ID of the product detection sensor 6 as indicated by the product-return-action information as well as the skeleton information and the feature information of a visitor. Irrespective of releasing the association between the visitor ID and the product ID, the processed-subject identification part 15 of the store management device 1 may determine a visitor ID corresponding to a processed-subject person from the visitor data table.

Based on an image captured by the second camera 5 instead of the detected information of the product detection sensor 6, the action detection part 14 of the store management device 1 may detect the identification information of a product taken by a visitor's a hand and coordinates of the product on the product shelf 21 in the store 20. Alternatively, the action detection part 14 may detect the identification information of a product which a visitor has returned to the product shelf 21 and coordinates of the product on the product shelf 21 in the store 20 based on an image captured by the second camera 5. That is, the action detection part 14 should detect a moving action of a visitor who may move a product based on at least one of the detected information of the product detection sensor 6 and the image information of the second camera 5.

According to the aforementioned processes, the sales management part 16 of the store management device 1 may store the information as to which product a visitor has taken by hand or the information as to which product a visitor has returned to the product shelf 21. In addition, the visitor selection part 11 may acquire a facial image of a visitor when leaving the store 20 through the entry/exit gate 2 from the entry/exit camera 24 so as to delete the visitor ID determined based on a feature quantity of the visitor's facial image from the visitor data table. The sales management part 16 is able to automatically detect a visitor's purchased product according to the relationship between the product ID and the visitor ID recorded on the sales management information of the database 40 when the visitor leaves from the store 20 through the entry/exit gate 2. The sales management part 16 is able to carry out an automatic settlement process using the visitor ID and the product ID recorded on the database 40 as well as a visitor's credit card number used to settle payment of products.

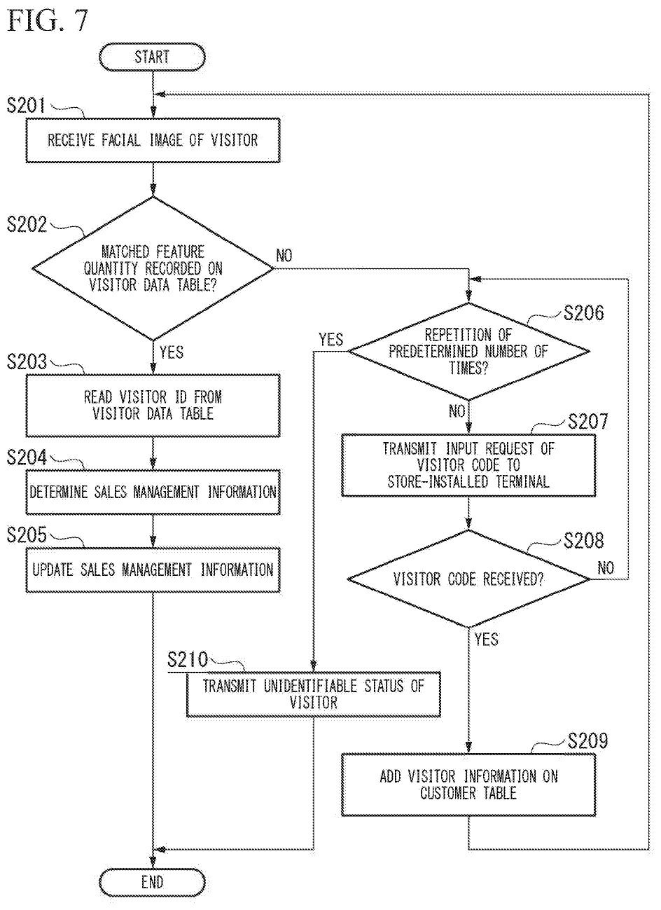

FIG. 7 is a flowchart of a first visitor-identifying process of the store management device 1 (i.e. steps S201 through S210). Next, a procedure for identifying a processed-subject person when updating the sales management information displayed on a display device (e.g. the store-installed terminal device 22 attached to the product shelf 21) installed in proximity to a visitor will be described below.

For example, it is assumed that a visitor walks around the store 20 and stops in front of a predetermined product shelf 21 so as to take a product displayed on the product shelf 21 by hand. In this case, the first position information acquisition part 12 of the store management device 1 is configured to generate the first position information representing three-dimensional coordinates of the facial feature information of a visitor (or a processed-subject person) approaching a product on the product shelf 21 in a space of the store 20 based on an image obtained from the first camera 3. The second position information acquisition part 13 of the store management device 1 is configured to generate the second position information representing three-dimensional coordinates of a distal end of a visitor's hand when a visitor (or a processed-subject person) extends an arm to reach a product by hand based on the sensing information obtained from the motion sensor 4. Subsequently, the action detection part 14 is configured to detect the third position information representing three-dimensional coordinates of a product positioned close to a distal end of a hand of a visitor (or a processed-subject person) based on coordinates of the product and the movement information of the product obtained from the product detection sensor 6. The action detection part 14 is configured to determine which visitor having the detected facial image has obtained which product on the product shelf 21 according to the relationship between the first position information, the second position information, and the third position information.

Next, a concrete procedure will be described with reference to FIG. 7. To determine a visitor ID, the visitor selection part 11 of the store management device 1 receives a facial image of a visitor from the entry/exit camera 24 (or the first camera 3) (S201). The visitor selection part 11 determines whether the visitor data table has stored a facial feature quantity identical to a feature quantity of the facial image of the visitor (S202). When the visitor data table has stored the facial feature quantity identical to the feature quantity of the facial image of the visitor, the visitor selection part 11 reads a visitor ID associated with the facial feature quantity from the visitor data table (S203). The visitor selection part 11 sends the visitor ID to the processed-subject identification part 15. This makes it possible for the processed-subject identification part 15 to identify a processed-subject person (i.e. a visitor or a registered user having the visitor ID). The processed-subject identification part 15 sends the visitor ID to the sales management part 16, which in turn determines the sales management information relating to the visitor ID (S204). The sales management part 16 will update a quantity of products and their IDs with respect to various types of products included in the sales management information based on a product ID which can be determined according to the third position information (S205). As described above, the sales management part 16 is able to update the sales management information.

Upon determining that the visitor data table has not stored a facial image having a feature quantity identical to the feature quantity of the facial image received from the entry/exit camera 24 (or the first camera 3) in step S202, the processed-subject identification part 15 determines whether a number of times of executing a determination process has reached a predetermined number of times (S206). Before the determination process of step S202 has not repeated the predetermined number of times, the processed-subject identification part 15 instructs the information output part 17 to output an input request of a visitor code. According to the instruction of the processed-subject identification part 15, the information output part 17 sends an input request of a visitor code to the store-installed terminal device 22 (i.e. one aspect of an input device in the present embodiment) installed in the product shelf 21 located proximate to the visitor (S207). The visitor code is a PIN (Personal Identification Number) or a personal secret code which is notified to a visitor in order to univocally identify a visitor. By requesting a visitor to input a PIN due to a failure to determine a visitor via face authentication using a feature quantity of a facial image, it is possible to improve authentication accuracy for visitors.

The store-installed terminal device 22 outputs an input request message which may urge a visitor to input a visitor code. In this connection, it is possible to produce sound as an input request message with a speaker. Accordingly, a visitor may input a visitor code through a user interface of an input device (e.g. the store-installed terminal device 22). The store-installed terminal device 22 transmits the visitor code to the store management device 1. The processed-subject identification part 15 of the store management device 1 determines whether the store management device 1 has received the visitor code from the store-installed terminal device 22 (S208). The database 40 stores an association between the visitor code and the corresponding registered user ID in advance. Upon receiving the visitor code, the processed-subject identification part 15 sends the visitor code to the visitor selection part 11. The visitor selection part 11 retrieves the registered user ID associated with the visitor code from the database 40, thus recording the registered user ID as a visitor ID on the visitor data table. The aforementioned procedure is one aspect of the procedure for the visitor selection part 11 to select a registered user corresponding to a visitor from among a plurality of registered users stored in advance based on the visitor code acquired from the input device. The processed-subject identification part 15 reads a facial feature quantity associated with the visitor ID from the database 40, thus recording the facial feature quantity on the visitor data table in association with the visitor ID. Accordingly, the processed-subject identification part 15 may add the information of a new visitor to the visitor data table (S209).

Thereafter, the visitor selection part 11 will repeat the determination process of step S202. When failing to receive the visitor code in step S208, the processed-subject identification part 15 may repeat the determination process of step S206. Upon determining that the number of times for determining that the visitor data table has not recorded the facial feature quantity identical to the feature quantity of the facial image received from the entry/exit camera 24 (or the first camera 3) has reached the predetermined number of times in step S206, the processed-subject identification part 15 transmits to the sales management part 16 an unidentifiable signal indicating a failure to identity a visitor (S210). Upon receiving the unidentifiable signal, the sales management part 16 stops updating the sales management information. Subsequently, the sales management part 16 displays notification information to notify a failure to identify a visitor on the store-installed terminal device 22. Accordingly, a visitor may recognize that the store management device 1 has failed to automatically identify the visitor.

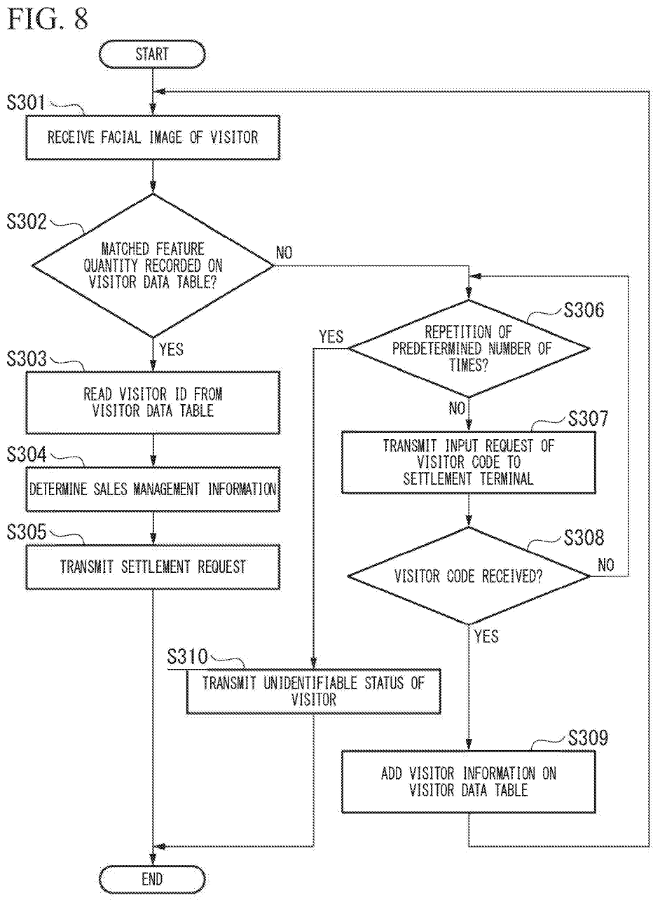

FIG. 8 is a flowchart of a second visitor-identifying process of the store management device 1 (steps S301 through S310). Next, a procedure for identifying a processed-subject person when executing an automatic settlement process using the visitor data table created according to the aforementioned procedure will be described below.

For example, it is assumed that a visitor may move to the foreside of a settlement terminal device installed in the store 20 in an automatic settlement process. The settlement terminal device is equipped with a camera configured to capture a facial image of a person (e.g. a visitor or a registered user) located in the foreside of the settlement terminal device. The camera may transmit the facial image of a visitor to the store management device 1. The visitor selection part 11 of the store management device 1 receives the facial image of a visitor from the camera (S301). The visitor selection part 11 is configured to determine whether the visitor data table has stored a facial feature quantity identical to a feature quantity of the facial image of the visitor (S302). When the visitor data table has stored a facial feature quantity identical to the feature quantity of the facial image of the visitor, the visitor selection part 11 reads a visitor ID associated with the facial feature quantity from the visitor data table (S303). The visitor selection part 11 sends the visitor ID to the processed-subject identification part 15. This makes it possible for the processed-subject identification part 15 to identify the visitor as a processed-subject person. The processed-subject identification part 15 sends the visitor ID to the sales management part 16. The sales management part 16 determines the sales management information holding the visitor ID (S304). The sales management part 16 acquires the quantity of products and their product IDs with respect to various types of products included in the sales management information. The sales management part 16 acquires an amount of payment registered in the database 40 in association with its product ID. The sales management part 16 calculates a total amount of payment based on an amount of payment for each product and the quantity of products relating to the product ID. The sales management part 16 acquires a credit card number registered in the database 40 in association with the visitor ID. The sales management part 16 transmits a settlement request including the total amount of payment and the credit card number to an external settlement serve connected thereto through a communication network (S305). Accordingly, the settlement server may carry out an automatic settlement process.

Upon determining that the visitor data table has not stored a facial feature quantity identical to the feature quantity of the facial image in step S302, the visitor selection part 11 determines whether the number of times of executing the determination process of S302 has reached a predetermined number of times (S306). Until the number of times for repeating the determination process does not reach the predetermined number of times, the processed-subject identification part 15 instructs the information output part 17 to output an input request of a visitor code. According to the instruction of the processed-subject identification part 15, the information output part 17 transmits an input request of a visitor code to the settlement terminal device (i.e. one aspect of an input device) (S307). In this connection, the visitor code may be a PIN which is notified to a visitor in order to univocally identify the visitor. Despite a failure to identify a visitor via face authentication using the feature quantity of a facial image, it is possible to improve authentication accuracy of a visitor by requesting the visitor to input a PIN.

An input device such as the settlement terminal device outputs an input request message which may urge a visitor to input a visitor code. Herein, it is possible to produce sound as the input request message with a speaker. Alternatively, it is possible to output the input request message on a monitor screen of the input device. Accordingly, the visitor inputs the visitor code through a user interface of the input device. The input device transmits the visitor code to the store management device 1. The processed-subject identification part 15 of the store management device 1 determines whether to input the visitor code therein (S308).

The database 40 records an association between the visitor code and the corresponding registered user ID in advance. Upon receiving the visitor code, the processed-subject identification part 15 sends the visitor code to the visitor selection part 11. The visitor selection part 11 retrieves the registered user ID associated with the visitor code from the database 40, thus recording the registered user ID as a visitor ID on the visitor data table. The visitor selection part 11 reads a facial feature quantity associated with the visitor ID from the database 40, thus recording the facial feature quantity on the visitor data table in association with the visitor ID. Accordingly, the visitor selection part 11 may record the information of a new visitor on the visitor data table (S309).

The visitor selection part 11 repeatedly executes step S302. When the processed-subject identification part 11 fails to receive the visitor code in step S308, the processed-subject identification part 11 repeatedly executes step S306. When the number of times for determining that the visitor data table has not recorded the facial feature quantity reaches the predetermined number of times in step 306, the processed-subject identification part 15 sends to the sales management part 16 an unidentifiable signal indicating a failure to identify a visitor (S310). Upon receiving the unidentifiable signal, the sales management part 16 stops the automatic settlement process. Subsequently, the sales management part 16 requests the settlement terminal device to carry out a normal settlement process. The settlement terminal device may urge a visitor (or a customer) to put money equivalent to the total amount of payment into a money inlet port by clearly indicating the visitor's purchased products.

Using the visitor data table, the store management device 1 may identify a visitor ID for predetermined processes such as an automatic settlement process, a process for presenting a list of recommended products, and a process for storing products put into a cart by a visitor (or products subjected to a visitor's moving action). That is, when determining the visitor ID for the sake of predetermined processes in the store 20, the store management device 1 calculates a matching degree between a feature quantity of a facial image of a new visitor and a feature quantity of a facial image which is recorded on the visitor data table in association with a visitor ID, thus determining a visitor ID having the highest matching degree from the records of the visitor data table configured to record the information of only the visitors extracted from numerous registered users. This may improve the accuracy of identifying visitors with the store management device 1. In addition, it is possible to increase the speed of executing the process for identifying the visitor ID with the store management device 1. In the aforementioned processes, face authentication is carried out to identify only the visitor who may respond to a request using the terminal device 7 held by a visitor or the store-installed terminal device 22 installed in the store 20. Thus, it is possible to carry out predetermined processes such as an automatic settlement process and a process of updating the sales management information with high accuracy without an error in identifying visitors.

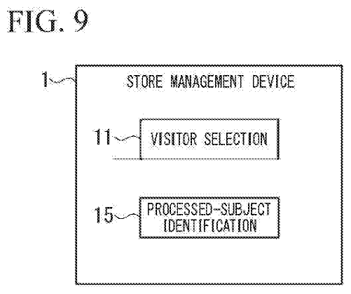

FIG. 9 shows a minimum configuration of the store management device 1. The store management device 1 includes at least the visitor selection part 11 and the processed-subject identification part 15. The visitor selection part 11 is configured to select a registered user corresponding to a visitor from among a plurality of registered users stored in advance. The processed-subject identification part 15 is configured to identity a visitor subjected to predetermined processes by way of an authentication process to be executed using a set of biological information of registered users corresponding to visitors and the biological information of a visitor newly detected at the timing of executing predetermined processes in the store 20.

The aforementioned store management device 1 has a computer system therein. The foregoing steps are stored as computer programs on computer-readable storage media. It is possible to achieve the foregoing steps with a computer which reads and executes computer programs. Herein, computer-readable storage media refer to magnetic disks, magneto-optical disks, CD-ROM, DVD-ROM, semiconductor memory and the like. In addition, it is possible to deliver computer programs to a computer through communication lines so that the computer can execute computer programs.

The aforementioned computer programs may achieve some of the foregoing functions. Alternatively, the aforementioned computer programs may be differential files (or differential programs) which can be combined with preinstalled programs of computer systems to achieve the foregoing functions.

Lastly, the present invention is not necessarily limited to the foregoing embodiment and may include various modifications or design changes within the scope of the invention as defined in the appended claims.

The present application claims the benefit of priority on Japanese Patent Application No. 2018-52718 filed on Mar. 20, 2018, the subject matter of which is hereby incorporated herein by reference.

### INDUSTRIAL APPLICABILITY

The present invention is designed to carry out an automatic settlement process using face authentication by way of collation between a facial feature quantity of a visitor in a store and a facial feature quantity of a registered customer. The present invention is configured to carry out an authentication process using combinations of persons' facial feature quantities and their biological information is applicable to various types of authentication devices installed in railroad facilities or airport facilities.

### REFERENCE SIGNS LIST

1 store management device
2 entry/exit gate
3 first camera
4 motion sensor
5 second camera
6 product detection sensor
7 terminal device
10 control part
11 visitor selection part
12 first position information acquisition part
13 second position information acquisition part
14 action detection part
15 processing-subject identification part
16 sales management part
17 information output part
20 store
21 product shelf
22 store-installed terminal device
24 entry/exit camera
40 database

1. A store management device comprising:
at least one memory configured to store instructions; and
at least one processor configured to execute the instructions to:
acquire an image including a visitor who visits a store;
select a registered customer corresponding to the visitor based on the image, from among a plurality of registered customers, by using biometric recognition;
transmit identity verification information to a terminal device of the selected registered customer;
store the registered customer on a visitor database, after receiving an approval information from the terminal device; and
identify the visitor as a processed-subject person subjected to a predetermined process by using the visitor database.

2. (canceled)

3. The store management device according to claim 1, wherein the at least one processor is configured to:
transmit an input request of a visitor code to the visitor in a case where the processed-subject person has not been identified; and
store the registered customer corresponding to the visitor code after receiving the visitor code as the approval information.

4. The store management device according to claim 1, wherein the at least one processor is configured to:
the processed-subject person subjected to the predetermined process with reference to the visitor database.

5. The store management device according to claim 1, wherein the at least one processor is configured to identify the processed-subject person, in a case where the visitor acquires a product.

6. The store management device according to claim 4, wherein the at least one processor is configured to:
calculate a matching degree between biological information of the registered customer corresponding to the visitor and biological information of the visitor acquired at the predetermined process in the store; and
identify the processed-subject person, based on the calculated matching degree.

7. A store management method comprising:
storing instructions using at least one memory; and
executing instructions, using the at least one processor, to:
acquire an image including a visitor who visits a store;
select a registered customer corresponding to the visitor based on the image, from among a plurality of registered customers, by using biometric recognition;
transmit identity verification information to a terminal device of the selected registered customer;
store the registered customer on a visitor database, after receiving an approval information from the terminal device; and
identify the visitor as a processed-subject person subjected to a predetermined process by using the visitor database.

8. A non-transitory computer-readable storage medium having a stored program executed by a computer, comprising:
at least one memory configured to store instructions; and
at least one processor configured to execute the instructions to:
acquire an image including a visitor who visits a store;
select a registered customer corresponding to the visitor based on the image, from among a plurality of registered customers, by using biometric recognition;
transmit identity verification information to a terminal device of the selected registered customer;
store the registered customer on a visitor database, after receiving an approval information from the terminal device; and
identify the visitor as a processed-subject person subjected to a predetermined process by using the visitor database.

9. The store management device according to claim 1, wherein the at least one processor is configured to identify the processed-subject person, in a case where the visitor has been captured by a camera installed on a settlement device.

10. The store management device according to claim 5, wherein the at least one processor is configured to detect that the visitor acquires a product by using a sensor sensing a change of weight.

11. The store management device according to claim 1, wherein the predetermined process is a settlement process.

12. The store management device according to claim 1, wherein the at least one processor is configured to delete, after the visitor has left the store, the registered customer corresponding to the visitor that left the store from the visitor database.
